(19) United States
(12) Patent Application Publication
(10) Pub. No.: US 2025/0363186 A1
(43) Pub. Date: Nov. 27, 2025

(54) Tensor Network Systems For Design Synthesis And Optimization Tools

(71) Applicant: The Regents of The University of Michigan, Ann Arbor, MI (US)

(72) Inventors: Connor ARRIGAN, Ann Arbor, MI (US); David SINGER, Ann Arbor, MI (US); Alexander MANOHAR, Ann Arbor, MI (US)

(21) Appl. No.: 19/216,266

(22) Filed: May 22, 2025

Related U.S. Application Data
(60) Provisional application No. 63/651,247, filed on May 23, 2024.

(51) Int. Cl. G06F 17/16

(52) U.S. Cl. CPC G06F 17/16

(57) ABSTRACT

An example computer system includes memory hardware configured to store computer-executable instructions, and a design tool model. The system includes processor hardware configured to execute the computer-executable instructions to obtain multiple input parameters each associated with the design tool model, obtain multiple output objectives each associated with the design tool model, build at least one tensor network between the multiple input parameters and the multiple output objectives, the at least one tensor network including one or more tensors each connected between at least one of the multiple input parameters and at least one of the multiple output objectives, and perform one or more contractions of the at least one tensor network to generate a contraction result, the contraction result indicative of an effect of at least one of the multiple input parameters on at least one of the multiple output objectives.

### CROSS-REFERENCE TO RELATED APPLICATION

This application claims the benefit and priority of U.S. Provisional Application No. 63/651,247 filed on May 23, 2024. The entire disclosure of the above application is herein incorporated by reference.

### GOVERNMENT LICENSE RIGHTS

This invention was made with government support under N00014-21-1-2795 awarded by the U.S. Office of Naval Research. The government has certain rights in the invention.

### FIELD

The present disclosure relates tensor network system for design synthesis and optimization tools.

### BACKGROUND

Design optimization is an area of single-criteria or multiple-criteria decision making that is concerned with mathematical optimization problems involving one or more objective functions to be optimized. Multi-objective optimization (or single objective optimization) may be used in a variety of fields, such as engineering design models (e.g., for bulk carrier vessels). Design synthesis tools and optimization tools often struggle to map the unique interactions between design variables, operational constraints, and performance objectives.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

An example computer system includes memory hardware configured to store computer-executable instructions, and a design tool model. The system includes processor hardware configured to execute the computer-executable instructions to obtain multiple input parameters each associated with the design tool model, obtain multiple output objectives each associated with the design tool model, build at least one tensor network between the multiple input parameters and the multiple output objectives, the at least one tensor network including one or more tensors each connected between at least one of the multiple input parameters and at least one of the multiple output objectives, and perform one or more contractions of the at least one tensor network to generate a contraction result, the contraction result indicative of an effect of at least one of the multiple input parameters on at least one of the multiple output objectives.

In some examples, the processor hardware is configured to obtain multiple binding conditions each associated with the design tool model, build a second tensor network between the multiple input parameters and the multiple binding conditions, the second tensor networks including one or more tensors connected between at least one of the multiple input parameters and at least one of the multiple binding conditions, and perform one or more contractions of the second tensor network to generate a second contraction result, the second contraction result indicative of an effect of at least one of the multiple input parameters on at least one of the multiple binding conditions. In some examples, the multiple binding conditions include at least one of a binding condition or a near-binding condition.

In some examples, the processor hardware is configured to obtain multiple optimality conditions each associated with the design tool model, build a third tensor network between the multiple input parameters and the multiple optimality conditions, the third tensor network including one or more tensors connected between at least one of the multiple input parameters and at least one of the multiple optimality conditions, and perform one or more contractions of the third tensor network to generate a third contraction result, the third contraction result indicative of an effect of at least one of the multiple input parameters on at least one of the multiple optimality conditions.

In some examples, the multiple optimality conditions include at least one of a pareto condition or a near-pareto condition. In some examples, building the third tensor network includes building one or more tensors between the multiple output objectives and the multiple optimality conditions, and the third contraction result is indicative of an effect of at least one of the multiple output objectives on at least one of the multiple optimality conditions.

In some examples, the processor hardware is configured to obtain multiple constraint parameters each associated with the design tool model, build a fourth tensor network between the multiple input parameters and the multiple constraint parameters, the fourth tensor network including one or more tensors each connected between at least one of the multiple input parameters and at least one of the multiple constraint parameters, and perform one or more contractions of the fourth tensor network to generate a fourth contraction result, the fourth contraction result indicative of an effect of at least one of the multiple input parameters on at least one of the multiple constraint parameters. In some examples, at least one of the constraint parameters is coupled with less than all of the multiple input parameters via the fourth tensor network.

In some examples, the design tool model is a bulk carrier optimization design model. In some examples, the multiple input parameters include at least one of a vessel length parameter, a vessel draft parameter, a vessel depth parameter, a block coefficient parameter, a vessel beam parameter, and a vessel speed parameter.

An example method of executing tensor networks for design tool synthesis or optimization includes obtaining multiple input parameters each associated with a design tool model, obtaining multiple output objectives each associated with the design tool model, building at least one tensor network between the multiple input parameters and the multiple output objectives, the at least one tensor network including one or more tensors each connected between at least one of the multiple input parameters and at least one of the multiple output objectives, and performing one or more contractions of the at least one tensor network to generate a contraction result, the contraction result indicative of an effect of at least one of the multiple input parameters on at least one of the multiple output objectives.

In some examples, the method includes obtaining multiple binding conditions each associated with the design tool model, building a second tensor network between the multiple input parameters and the multiple binding conditions, the second tensor network including one or more tensors connected between at least one of the multiple input parameters and at least one of the multiple binding conditions, and performing one or more contractions of the second tensor network to generate a second contraction result, the second contraction result indicative of an effect of at least one of the multiple input parameters on at least one of the multiple binding conditions. In some examples, the multiple binding conditions include at least one of a binding condition or a near-binding condition.

In some examples, the method includes obtaining multiple optimality conditions each associated with the design tool model, building a third tensor network between the multiple input parameters and the multiple optimality conditions, the third tensor network including one or more tensors connected between at least one of the multiple input parameters and at least one of the multiple optimality conditions, and performing one or more contractions of the third tensor network to generate a third contraction result, the third contraction result indicative of an effect of at least one of the multiple input parameters on at least one of the multiple optimality conditions.

In some examples, the multiple optimality conditions include at least one of a pareto condition or a near-pareto condition. In some examples, building the third tensor network includes building one or more tensors between the multiple output objectives and the multiple optimality conditions, and the third contraction result is indicative of an effect of at least one of the multiple output objectives on at least one of the multiple optimality conditions.

In some examples, the method includes obtaining multiple constraint parameters each associated with the design tool model, building a fourth tensor network between the multiple input parameters and the multiple constraint parameters, the fourth tensor network including one or more tensors connected between at least one of the multiple input parameters and at least one of the multiple constraint parameters, and performing one or more contractions of the fourth tensor network to generate a fourth contraction result, the fourth contraction result indicative of an effect of at least one of the multiple input parameters on at least one of the multiple constraint parameters. In some examples, at least one of the constraint parameters is coupled with less than all of the multiple input parameters via the fourth tensor network.

In some examples, the design tool model is a bulk carrier optimization design model. In some examples, the multiple input parameters include at least one of a vessel length parameter, a vessel draft parameter, a vessel depth parameter, a block coefficient parameter, a vessel beam parameter, or a vessel speed parameter.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIGS. 1A and 1B are functional block diagram of example tensor networks including two nodes linked via multiple coupling tensors.

FIG. 2 is a functional block diagram of the example tensor network of FIG. 1, with two external legs connected to different tensors.

FIG. 3 is a functional block diagram of the example tensor network of FIG. 1, with an anchor connected to a tensor.

FIG. 4 is a diagram of an example general structure for a tensor network.

FIG. 5 is an example bulk carrier tensor system, which may be used to analyze a bulk carrier optimization problem.

FIG. 6 illustrates an example bulk carrier tensor system, which may be used to analyze binding, non-binding and near-binding conditions in a bulk carrier optimization problem.

FIG. 7 illustrates an example bulk carrier tensor system, which may be used to analyze optimality conditions.

FIG. 8 illustrates an example bulk carrier tensor system, which may be used to analyze the effects of constraints in a bulk carrier optimization problem.

FIG. 9 is a block diagram illustrating an example process for analyzing a design synthesis or optimization tool using tensor networks.

In the drawings, reference numbers may be reused to identify similar and/or identical elements.

### DETAILED DESCRIPTION

### Tensor Network Systems for Design Synthesis and Optimization Tools

Described herein are some example embodiments of frameworks designed to convert an engineering or physics based design synthesis and optimization tools into networks which can be used in combination with tensors and concepts from statistical physics for analysis of trends across populations of solutions, diagnostics of populations of solutions, informed design decision making, etc. Traditionally, design tools and optimization tools often struggle to map the unique interactions between design variables, operational constraints, and performance objectives.

Tensor networks, a mathematical framework rooted in quantum physics (e.g., statistical physics), address this challenge by providing a tool to model state relationships within multidimensional data structures. A state space representation offers a holistic understanding of design tools and the populations of solutions they produce by providing insights that add to traditional analysis techniques. Some example embodiments include a methodology for converting an optimization problem or design tool into tensor network representations, detailing the implementation of tensor network algorithms, and a capacity of tensor networks to provide a deep, data-driven understanding of relationships and interdependencies within complex design tools, which may enable novel decision-making opportunities.

In some examples, statistical physics may be applied to extract information about objects via tensor networks, with partition functions that describe state-to-state relationships within the system. Some example embodiments employ one or more tensor networks to decouple the scale of the environment from diagnostic decision-making. Individual tensor networks can be contracted by decentralized agents and can obtain important contextual information from connected components via the tensor network.

For example, statistical physics is a branch of quantum physics concerned with understanding the behavior of large-scale systems based on the interactions between their individual components, largely via tensor networks. Tensor networks may include networks of n-dimensional arrays, and may provide a powerful framework for investigating highly correlated and entangled, complex systems.

Tensor networks may efficiently represent all possible combinations of components states and their connection to other components and their respective states, which may allow one to rapidly query the state space and obtain probability distributions across different components and their respective states through performing contractions. The tensor networks may be used for analysis in any suitable environments, such as the marine domain (e.g., a bulk carrier design tool, a ship arrangements problem, self-adaptive health monitoring, etc.).

In some examples, tensor networks provide a strong framework for investigating optimization codes, as one can easily investigate the impact of individual or multiple components across certain or changing states. While traditional optimization methods struggle to uniquely map the complex interactions between design variables, operational constraints, and performance objectives, tensor networks provide a powerful tool to unravel state relationships within multidimensional data structures. Tensor networks enable simultaneous analysis of multiple constraints and their interactions, offer a holistic understanding of the optimization landscape, and provide design process insights that may otherwise remain hidden.

Statistical physics uses of statistical methods to describe physical phenomena, such as thermodynamics, superfluidity, and quantum statistics. Partition functions and tensor networks are two of the information structures used in statistical physics. Partition functions are used to describe the statistical properties of a system. When the partition function is evaluated, statistical averages are generated over the system's state space with respect to an objective function O. The objective function may take into account various system configurations {α} which can act as various “partitions” of the system, and return the cost for the system to be in that configuration. Each configuration α is evaluated by the objective function O and outputs the expected outcome of the system using that configuration.

The output of the objective function may be used to find the probability of a system being in a particular configuration p_{α}. This probability is described below in the example Equation 1 below, where O and α are as described above and λ is the “relative importance of the corresponding design objective in driving the distribution”, or the configuration pressure.

$${p}_{α} = \frac{1}{𝒵} {e}^{- λ𝒪 ( α )} \qquad Equation 1$$

The normalization constant Z is the summation over all possible system configurations {α}, and is described in the example Equation 2 below. Z may also be referred to as the partition function of the system.

$$Z = {\sum }_{α} \begin{matrix}{e}^{- T * O ( α )} & \end{matrix} \qquad Equation 2$$

The partition function Z may be used to examine the system and how various configurations affect it via soft constraints (e.g., configuration pressure λ) and hard constraints (e.g., system configurations α). The partition function contains a vast amount of information about the system, and it can be extracted by encoding the partition function into a tensor network. The tensor network may be evaluated by contracting it to obtain statistical information about the system.

In some examples, the partition function Z Provides a connection between the microscopic properties of individual particles and the macroscopic properties of the entire system. It may be defined as a sum of Boltzmann factors, which are exponential functions of the system's energy at each state (e.g., the exponential term in Equation 2). The partition function Z may sum over all possible system state configurations (alpha), and T represents the critical temperature of the system (e.g., where a larger value of T represents a sharper distribution).

The objective function O (α) returns the system's energy while at state configuration α. The objective function can be configured for varying goals, and defines state-to-state relationships via the energy between states. A lowest objective state may have a highest probability.

In various implementations, a tensor network is centered around physical components (e.g., a pump, a pipe, etc.). For example, a tensor network may include different types of nodes, such as a physical node representing a physical component's state, a sensor node representing sensor reading states, input variables to a design synthesis or optimization tool, output objectives, binding conditions, design model constraints, etc. As explained further below, anchors or other tensor system features may be used to, for example, place an external leg on a node to obtain a probability distribution over a state space.

A tensor network may include a network of tensors whose edges represent contractions between them. A tensor is an algebraic object that represents physical relationships between two objects. An example is a stress tensor that relates the amount of stress that is being placed upon an object. In a mathematical sense, a tensor may be a “series of numbers labeled by N indexes, with N called the order of the tensor”. For example, a scalar is a 0th order tensor, a vector is a 1st order tensor, and a matrix is a 2nd order tensor. A contraction between two tensors is a summation over a shared index. Therefore, a tensor network may represent a series of contractions between tensors. Tensor network contraction is commutative, so the order that the edges are contracted over does not affect the end result.

In some examples, different pieces of information about a system may be used to construct the tensor network: the system's logical architecture, the system's physical architecture, and an objective function to define the state-to-state relationships between components in the system. First, a system consists of a series of components that have some relationships with other components. The logical architecture of the system is a network where the nodes are components of the system, and the edges represent the existence of relationships between components. Next, the physical architecture of the system is the state space of the system. Each component has a corresponding state space and the combination of all of the components' states forms the system's state space. The objective function defines the state-to-state relationships between components. From these three information structures, a tensor network may be constructed which can be used to investigate the system.

There are several tools which may be used to modify the tensor network, including external legs, anchors, and modified couplings. Each of these tools modifies the tensor network in a unique way which facilitates interrogation of the tensor network to learn the statistical properties of the system. For example, the coupling between nodes may be directly modified. Normally, the objective function determines the values of the coupling tensor between two nodes, but the coupling may be modified to denote a special relationship between two nodes.

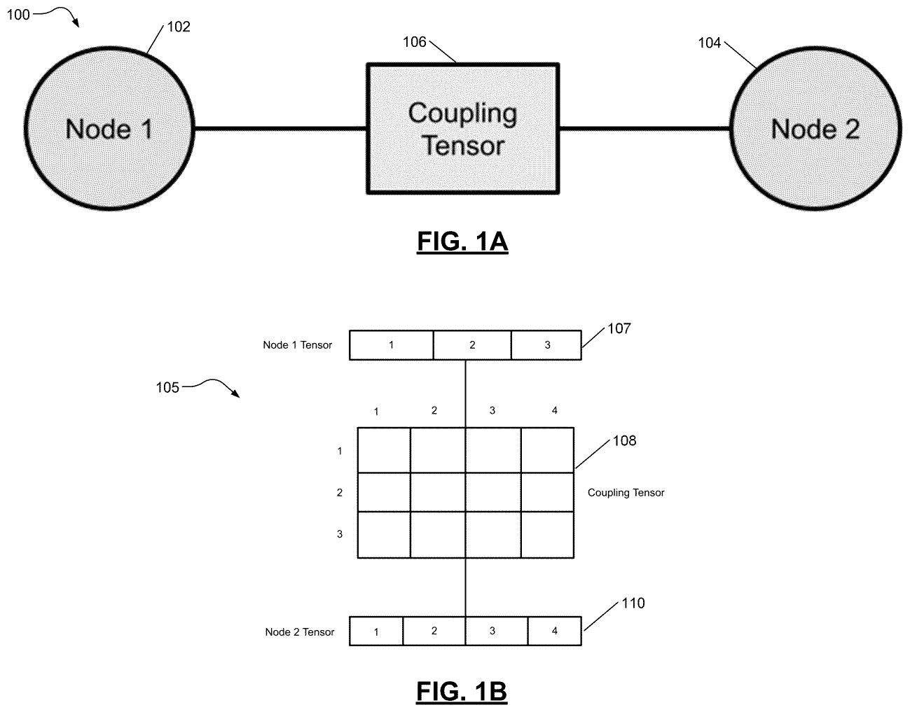

FIG. 1A illustrates an example tensor network 100 including a first node 102 and a second node 104. The first node 102 is linked with the second node 104 via a coupling tensor 106. The first node 102 and the second node 104 may each be tensors.

Coupling tensors (e.g., edges of the tensor network architecture), may represent contraction between two tensors in a network, where the coupling tensors have a rank of 2. In some example embodiments, point-wise mutual information may be used as a surrogate for energy in the coupling tensor. In other implementations, other parameters or values could be used in the coupling tensor. Each value in the coupling tensor may be point-wise mutual information of two respective states. Point-wise mutual information may act as a surrogate for energy. An example equation for a coupling tensor is provided below:

$$PMI ( a , b ) = log ( \frac{P ( a , b )}{P ( a ) * P ( b )} ) \qquad Equation 3$$

As an example, a first node may include an input vector such as all possible lengths for a vessel. A coupling tensor may be calculated, where a second node is then an output vector of all possible states of an output objective (e.g., total transportation costs for a vessel, etc.).

FIG. 1B illustrates an example tensor network 105 including a first node 107 and a second node 110. The first node 107 is linked with the second node 110 via a coupling tensor 108. The first node 107 and the second node 110 may each be tensors. Although FIG. 1B illustrates example dimensions for the first node 107, the second node 110 and the coupling tensor 108, in other example embodiments each node and each coupling tensor may have different dimensions, the system may have more nodes or more coupling tensors, etc.

As another option, external legs may be attached to the nodes in the tensor network to prevent the node's tensor from disappearing into the contraction. For example, external legs prevent tensors from being incorporated into the partition function summation. An artificial index may be used to prevent contraction.

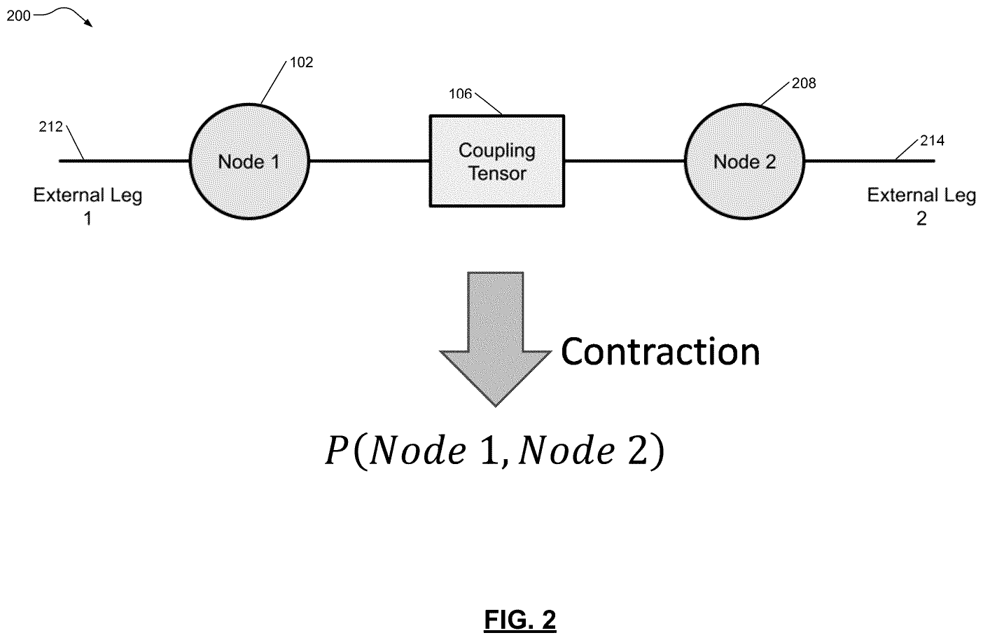

The remaining tensor provides an unnormalized probability distribution over the node's state space. External legs may also be attached to multiple nodes simultaneously. The result is an unnormalized joint probability over the state spaces of the nodes. FIG. 2 illustrates an example tensor network 200 with a first external leg 212 connected to the first node 102. A second external leg 214 is connected to the second node 208. For example, the tensor network 200 of FIG. 2 may be similar to the tensor network 100 of FIG. 1, with external legs connected to each node.

As yet another option, anchors may be attached to a node's specific state. Anchors may represent a decision that has been made or information about the node that is already known. In this case, contraction of the tensor network is conditioned on the anchored node's state. Anchors may be placed on multiple nodes to condition the system on their states. A specified configuration may be held constant over a partition function summation.

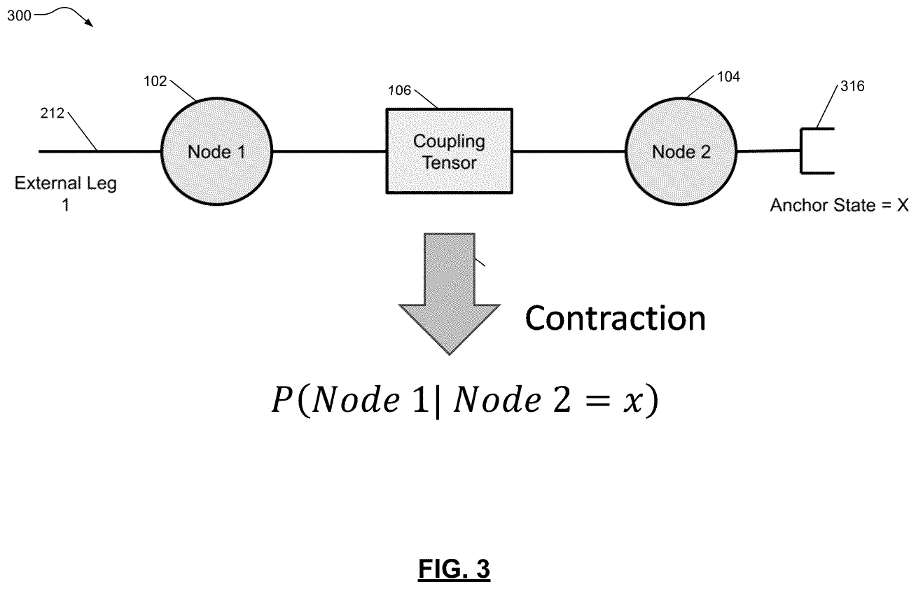

FIG. 3 illustrates an example tensor network 300 with an anchor 316 connected to the second node 104. The anchor 316 affects the contraction result, as shown in FIG. 3. For example, the tensor network 300 of FIG. 3 may be similar to the tensor network 200 of FIG. 2, but with an anchor 316 coupled to the second node 104 instead of an external leg.

Using external legs, anchors, and modified couplings, one can interrogate a system via its tensor network representation to generate ensembles of information about the state spaces of the various system's components. Tensor network contraction is a quick operation due to it being a generalization of the inner product of vectors, and the hyper-optimized methods for computing those dot products (such as those included in the Python package PyTorch). Since tensor network contraction is commutative, the output does not depend on the order that the network is contracted. When two tensors are contracted, the number of remaining leftover indices determines the dimension of the resulting tensor. For example, if a 4th and 3rd dimensional tensor are contracted, then the resulting tensor is a 5th dimensional tensor. Hyper-optimized tensor contraction path-finding algorithms often rely on lattice-like grid structures, and even when they do not, their run time may be exponential on the scale of O(2^{E}) where E is the number of edges in the network. Therefore, in order to use the tensor network to generate ensembles of information about systems, it may be desirable to limit the number of edges in the network while retaining the capabilities of a larger network. The reduction of edges allows greedy pathfinding algorithms to find optimal contraction paths quickly. This effectively decouples the time and space requirements of the tensor network from the complexity of the system if the system's tensor network representation does not rely on a dense network.

Some example embodiments described herein may implement tensor networks on any suitable computing architecture, which may include one or more databases, system controllers, processors, servers, etc. For example, the tensor networks may be deployed in a computer network system, a standalone computer setup, may include a desktop computer, a laptop computer, a tablet, a smartphone, etc.

Data related to the tensor networks may be located in different physical memories within one or more databases, such as different random access memory (RAM), read-only memory (ROM), a non-volatile hard disk or flash memory, etc. In some implementations, data may be located in the same memory (such as in different address ranges of the same memory). In various implementations, data may be stored as structured or unstructured data in any suitable type of data store.

In various implementations, users may access the tensor networks via a user device. The user device may include any suitable user device for displaying text and receiving input from a user, including a desktop computer, a laptop computer, a tablet, a smartphone, etc. In various implementations, the user device may access the system directly, or may access system through one or more networks. Example networks may include a wireless network, a local area network (LAN), the Internet, a cellular network, etc.

### General Network Structure, State Space and Energy

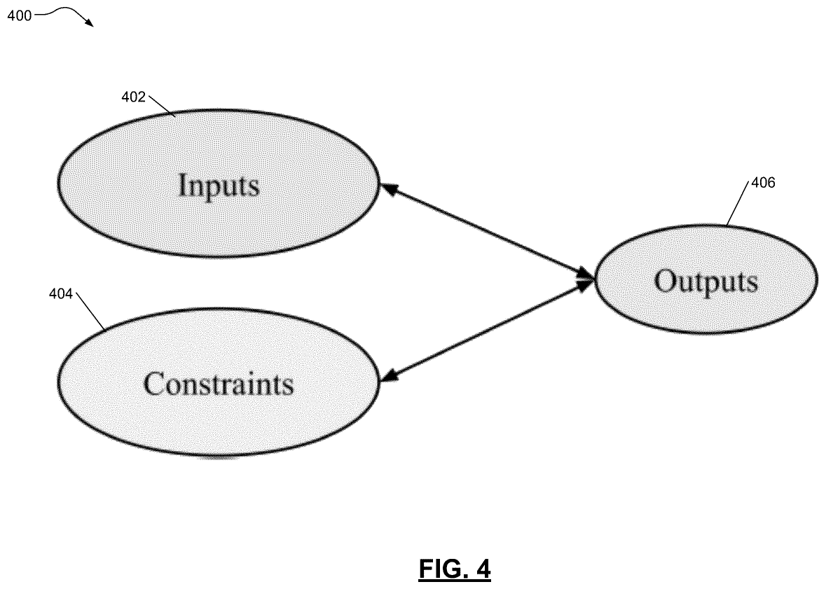

FIG. 4 is a diagram of an example general structure 400 for a tensor network. The definition of a network structure may be pivotal to the effectiveness and insights afforded by a framework. For example, some structures may avoid loops and strive to be as planar and tree-like as possible to facilitate efficient contraction. In some cases, a large tensor network itself may not constitute a limitation on the framework, but a primary constraint on size may arise from a definition of the state space. This may create challenges not in the expanse of the tensor network, but in managing the state space effectively to enable meaningful analysis.

Statistical physics employs a state-based approach, with the definition of possible quantum states. Generally, states may be defined as any measurable quantitative or qualitative property of the system or its components. Within some example designs, a state may be represented by a design point exhibiting distinct characteristic values. A change in state or the emergence of a new state may occur when the design point assumes one or more different characteristics.

In some examples, where populations of solutions are utilized, states may be defined in relation to a population, where each population is possessed of a set of states determined by the individuals within it. States may be assigned to each node (e.g., variable/tensor), in the tensor network. In some example case studies, a unique state may be identified based on a level of truncation (e.g., 0.1, 0.01, 0.001) of the values of each variable in the tensor network.

As an example, if a tensor network incorporates a variable/state tensor X, with a population consisting of 250 individuals, there may be at most 250 distinct states for X if each individual in the population has a unique value of X, depending on a level truncation applied.

In other examples, alternative state designs may be used, such as a qualitative state definition which categorizes states based on properties such as feasibility, near-optimality, or Pareto optimality. Such a state definition may be used to generate distributions of design parameters and objectives. Thus, when evaluating different goals, it is important to consider various approaches to state definitions, as each will provide unique insights suited to specific research aims.

Wherever an edge is present relating to two variable nodes, a coupling matrix may be present. The coupling matrix, a rank two tensor, may take the size of the number of rows, being the number of states of one of the variables and the number of columns being the number of states of the second related variable. The coupling tensor may represent all possible combinations of the states of the two related nodes. The value within each of the cells of the coupling tensor may represent the energy level of the system in that given state combination. This energy may be defined by the system's objective function. The objective function may not be the same as or related to objective functions as used in optimization. This objective function may return the system's energy while at state configuration α. The objective function may be equivalent to the system's Hamiltonian at configuration α. The objective function can be configured for varying goals as long as its valuation generally represents the energy of the system. Fundamentally, the objective function may define state-to-state relationships via the energy between states.

In traditional statistical physics, the objective function is defined either to be the Helmholtz Free Energy (F), used in systems at constant volume and temperature, or the Gibbs Free Energy (G), used in systems at constant pressure and temperature. A goal of statistical physics is often to minimize the free energy of the system. That being said, in some examples described herein, any quantifiable surrogate for energy can be used as the object function, but the choice of the objective function (energy) should align with the intended insights to be gleaned. The framework may be set up like traditional statistical physics, where the lowest objective state will have the highest probability to minimize free energy of the system.

Because a main goal of the example framework is to allow for contextual comparison of ‘truth’ relative to a universe of discourse to identify ontological commitment via asking casual queries, a sensible measure for energy may be the measure of frequency. In some examples described herein, the objective function, the value within each of the cells of the coupling tensor, represents the frequency (e.g., energy) of a design point in the population occurring in a given state combination.

Frequency may serve as a reasonable objective function for several reasons, particularly in the context of comparing and understanding ‘truth’ within a specified universe of discourse. Given that the aim is to identify ontological commitments by posing causal queries, how frequently a certain state occurs, represented as frequency, provides a direct measure of the prevalence or likelihood of various state combinations within a given context or population. Frequency, in this context, is analogous to measuring energy, because it provides a quantifiable and objective basis to assess how often specific combinations of design points occur across multiple states. These measurements capture patterns and correlations between variables, contributing to understanding which states are more probable or impactful in certain scenarios. Therefore, frequency may encapsulate the vital characteristics of “how often” something happens, which is critical when examining the relationships and dependencies between variables from an empirical standpoint.

Utilizing the state distribution with frequency as its objective function means that the distributions generated by statistical physics and the tensor network represent the distribution of expected states relative to all components included in the tensor network. These distributions illustrate the varying probabilities of state combinations occurring within the scope of the tensor network, capturing the dynamics and variability inherent in the given population. By generating these distributions, one can observe which state-combinations of variable values are more common or rare, leading to insights into the underlying relationships between different variables.

These frequency-derived distributions may be important for determining non-encoded relationships between variables. In other words, by analyzing how often certain combinations appear compared to others, one can infer potential causal links and dependencies that are not explicitly encoded in the model, but are suggested by the population's structure. This approach allows for a more nuanced understanding of the interdependencies and interactions that exist, offering deeper insights into the complex web of relationships within the design tool under study. Using the frequency as an objective function serves as a gateway into exploring the causal and thus, ontological architectures within the universe of discourse.

With an example goal of a framework being aimed at identifying ontological commitments, networks may be systematically constructed by aligning inputs and constraints to a directional change of outputs. This approach may provide the capacity to mirror the structure of a design tool employed, where the network structure maintains fidelity to the tool while enabling a robust comparison of truth against the universe of discourse.

This approach may also elucidate non-encoded relationships between constraints, inputs and outputs. While intermediate functions may furnish additional detail, they may be excluded from some frameworks as they represent known encoded relations. Although their impact may be vital, it can be understood by examining the overarching inputs, outputs and constraints. Excluding intermediate functions may also limit the state space for analysis of case studies.

In some examples, such as various case studies, specific details of the network structure may be set by adapting the general structure to the nuances of each scenario. If a different design tool is employed, the general architecture of the network may remain consistent, albeit with modifications to specific nodes depending on the tool's particular characteristics. For example, in cases where the tool lacks explicit constraints, the network may be simplified by directly connecting inputs to outputs.

FIG. 4 illustrates an example an example general structure 400 for general construction of for a tensor network, which includes multiple inputs 402 and constraints 404, linked with outputs 406. In some examples, deliberate construction of the network structure may equip the framework to provide insightful analysis while remaining adaptable to veracious tools and contexts. Successfully navigating these structural considerations may enable the framework to serve its objective of revealing ontological commitments within diverse design scenarios.

### Boson-to-Fermion Ratio and Cartwright Causality Condition

In statistical physics, microscopic particles are categorized based on their intrinsic quantum mechanical properties, particularly their spin. Subatomic particles fall into one of two categories: bosons or fermions. Bosons are particles that have integer spins (0, 1, 2, . . . ). Some examples include photons (spin-1), the W and Z bosons (spin-1), gluons (spin-1), and the Higgs boson (spin-0). Bosons obey Bose-Einstein statistics, meaning that multiple identical bosons can occupy the same quantum state simultaneously. The statistical distribution that governs the number of bosons in various energy states at thermal equilibrium is the Bose-Einstein distribution. At low temperatures, a large fraction of bosons can occupy the lowest quantum state due to Bose-Einstein condensation. In this condensed phase, many properties of the system can become temperature-independent. For example, in a pure Bose-Einstein condensate, the density of particles in the ground state becomes nearly constant as temperature approaches zero.

On the other hand, fermions are particles with half-integer spins (1/2, 3/2, . . . ). Examples include electrons, protons, neutrons, and neutrinos all with spin-1/2. Unlike bosons, fermions follow the Pauli Exclusion Principle, where no two fermions can occupy the same quantum state simultaneously. This principle leads to the formation of shell structures in atoms and the stability of matter. Fermions are described by the Fermi-Dirac distribution, which dictates the distribution of fermions over energy states in thermal equilibrium. Like Bose-Einstein statistics, for systems described by Fermi-Dirac statistics, particularly at low temperatures, many physical properties also become nearly independent of temperature.

One can classify designs as particles and their characteristics representing subatomic particles. Designs that resemble fermions can be seen as unique creations where each design characteristic (subatomic particle) has a unique value that is not shared by any other design in a given population. This reflects the Pauli Exclusion Principle, where no two fermions can occupy the same quantum state simultaneously. Conversely, designs that resemble bosons have one or multiple shared design characteristics (subatomic particles) having a value that is shared by other designs in a given population. This is akin to how multiple identical bosons can occupy the same quantum state simultaneously.

The presence of multiple designs having characteristics in the same state or uniquely different states is not inherently good or bad; rather, it is an artifact of the tools or methods employed during the design process. One can examine the meaning and the positives and negatives of each. Looking at when multiple design points occupy the same state, this typically means or indicates one of three things—Convergence: This could indicate that a design optimization has reached a point of convergence, where different initial parameters or constraints lead to similar solutions. Optimal Design: It may suggest that this particular state represents an optimal or near-optimal solution within the defined design space and constraints. In this case, it could also mean that a design optimization is getting stuck in a local optimum. Lack of Diversity in the Design Space: It might also imply that the exploration of the design space was limited, potentially due to constraints, leading to similar solutions.

Regarding positives of multiple designs having characteristics in the same state, some examples include—Confidence in Solutions: Consistency among design points can provide confidence that the identified solutions are conceptually robust and potentially optimal. Simplified Decision-Making: A limited number of clear optimal designs can simplify decision-making processes, reducing the need for extensive further analysis. Reduced Computational Load: Fewer distinct solutions to evaluate can decrease the computational resources needed for more detailed analysis or validation.

However, there are also possible negatives of multiple designs having characteristics in the same state—Risk of Missing Alternatives: If the design space is not thoroughly explored, alternative designs that might perform better under different criteria or constraints can be overlooked. Local Optima: Multiple points converging to the same state might indicate a local optimum rather than a global one, especially if the optimization landscape is complex. An Over-constrained Problem: The problem may be overly constrained, limiting the exploration of potentially feasible alternative solutions.

One can also examine positives and negatives of multiple design points in ‘uniquely’ different states. When multiple design points occupy ‘uniquely’ different states, this typically means or indicates one of three things—Diversity in Designs: This result reflects a diverse set of solutions, possibly indicating a well-explored design space. Potential Trade-offs: Uniquely different designs may offer various trade-offs among design criteria, constraints, or objectives. A Complex Design Space: This can indicate a more complex design space with a highly dissected landscape containing many peaks or optimal regions.

Based on these possible meanings, some positives of multiple designs having ‘uniquely’ different characteristics may include—Flexibility in Decision-Making: The availability of multiple unique designs allows for flexibility in choosing a solution based on additional criteria or changing priorities. Innovative Solutions: Uniquely different solutions can lead to innovative approaches and unexpected design configurations. A Space Filling Exploration: Many uniquely different solutions can indicate a good exploration of the design space, capturing the breadth of possibilities and reducing the risk of missing a global optimum.

One can also consider some negatives associated with multiple designs having ‘uniquely’ different characteristics (states)—A Complex Decision Process: The need to choose from multiple designs can complicate the decision-making process, requiring additional criteria or analysis. Risk of Overfitting: With many solutions, there is a risk of selecting a design that fits particular scenarios well but is not conceptually robust across different conditions. Higher Computational Costs: Generating and evaluating multiple unique designs can be more computationally intensive for further analysis or validation.

In summary, the classification of microscopic particles as bosons or fermions offers a powerful metaphor for understanding design processes. By treating designs as akin to subatomic particles, one can derive valuable insights into the nature of design solutions. Designs that mirror fermionic principles reflect uniqueness and exclusivity, echoing the Pauli Exclusion Principle. Conversely, those resembling bosonic behavior demonstrate shared characteristics, similar to how identical bosons can occupy the same quantum state. These conceptual analogies highlight different facets of design space exploration whether it results in convergence on similar solutions due to optimization constraints or produces a diversity of distinct solutions, revealing the complexity of the design landscape.

Transitioning to a deeper exploration, one can turn one's attention to bosons as a compelling indicator of conceptual robustness. The ability of bosons to occupy the same quantum state embodies a form of robustness that is conceptually significant in design. Understanding bosons in this light brings the discussion from mere categorization to one that emphasizes the resilience and adaptability inherent in conceptually robust design solutions.

As referenced herein, a boson may be defined as a design that possesses one or more shared characteristics or states in response to a given query, whereas a fermion is defined as a design that has no shared characteristics or states for the same query. To analyze these designs, three key metrics are utilized: the cardinality of bosons, the cardinality of fermions, and the ratio of bosons to fermions. The cardinality metrics provide insight into the number of designs that exhibit shared versus unique characteristics, indicating the prevalence of each type. The ratio of bosons to fermions, defined as the sum of bosons over the sum of fermions for a set of queries, offers a deeper understanding of the conceptual robustness of a set of queries. A higher ratio suggests greater conceptual robustness, whereas a lower ratio indicates less. This idea of conceptual robustness is critical because, from an ontological perspective, it reflects the alignment between truth and the universe of discourse for a given set of queries.

Cartwright causality is defined as follows: C causes E if and only if C increases the probability of E in every situation which is otherwise causally homogeneous with respect to E. This translates to C→E iff P(E|C, K)>P(E|K) for all alt. causal factors and states of K.

The Cartwright causality condition articulates the necessity of considering the broader context in which a cause leads to an effect. It highlights the importance of not merely relying on a simplistic correlation between two variables but accounting for the complexity of the conditions under which this relationship holds. This directly captures the intent of ontological commitment in determining relations of truth to the universe of discourse. The relationship between causality and ontological commitment is described in more detail herein, elaborating on how understanding causality within the structured confines of these enabling conditions directly serves to identify ontological commitments.

Similar to the way a headache manifests in different states depending on various factors such as the type of headache, medical allergies, aspirin dosage, and timing of taking the aspirin, design, in much the same way, involves recognizing these different states, forming an extensive state space that delineates all possible scenarios and contexts. For the Cartwright condition to be effectively applied within the framework, it must be approached from a state and population-oriented perspective. This means examining causal interactions and ontological commitments not as isolated events but as part of broader, context-dependent patterns that exist across populations. This approach enables a better understanding of how specific conditions influence causal dynamics and allows for the identification of ontological commitments. In some examples, the Cartwright condition may be applied in a novel way to enable a better understanding of how specific conditions influence causal dynamics and allows for the identification of ontological commitments.

In some cases, the Cartwright condition is applied to single laws, scenarios, or events to determine whether a specified cause genuinely has the expected effect under particular circumstances. This involves checking that the causal relationship holds across different setups and interfering factors, denoted by the set K. However, in some examples described herein, the application of the Cartwright condition is expanded from a single, isolated causative event to a more complex state space representing an entire population. This includes careful consideration of all possible combinations of events, causes, and contextual factors, represented as E, C, and K, respectively, across a multidimensional space.

In order to streamline evaluating each state combination, some example frameworks utilize statistical physics and a tensor network. Statistical physics and the tensor network efficiently represent and manipulate high-dimensional data, such as the variables involved in the population state space of a design tool. In this framework, statistical physics and the tensor network are used to generate the necessary probability distributions to evaluate the Cartwright condition. By strategically placing external legs on the relevant variables within the tensor network, it becomes possible to generate the necessary probability distributions required for analysis. This process translates the raw state space data into structured joint distributions, facilitating subsequent probabilistic computations.

Once these joint distributions are developed, they can be reduced to marginal distributions using the fundamental laws of probability:

$$P ( A \vert B ) = \frac{P ( A ⋂ B )}{P ( B )}$$

$$P ( E \vert C ⋂ K ) = \frac{P ( E ⋂ C ⋂ K )}{P ( C ⋂ K )}$$

$$P ( E \vert K ) = \frac{P ( E ⋂ K )}{P ( K )}$$

Marginalization is an important step as it allows for focusing on specific variables of interest by summing out others, thereby simplifying the evaluation of the Cartwright condition. The condition must be tested within this marginalized context for every unique state of the population, ensuring that each combination of E, C, and context K is appropriately addressed. For a relationship to be considered causal in the traditional sense, it needs to fully (100%) satisfy the Cartwright condition across all possible configurations of the set K. This means that no matter how the possible influencing circumstances might vary, the cause must still reliably produce the effect.

In some examples, in the developed framework, C is a singular cause variable selected from the design tool. E is also a singular effect variable selected from the design tool. This means that both C and E each have several possible states based on the state space definition for the population. On the other hand, K can either be a singular variable or a set of variables selected from the design tool comprising equivalent effects of interest and all their possible states based on the state space definition for the population. This means that both P(E∩C∩K) and P(E∩K) are tensors. The P(E∩C∩K) tensor has the dimension of the number of states of E by the number of states of C by the number of states of Ki for all Ki in set K. The P(E∩K)) tensor has the dimension of the number of states of E by the number of states of Ki for all Ki in set K. Each cell of the tensor representing a state combination of a state of E a state of C and a state for each K holds the probability of the state combination generated by statistical physics and the given tensor network. The marginalization discussed above may be performed on these tensors, resulting in the marginalized tensors for condition checking with the Cartwright condition.

In applying the Cartwright condition to the P(E|C∩K) and P(E|K) tensors, each possible combination of microstates (each corresponding cell) is checked using the condition. The framework counts and outputs the number of both true and false microstate conditions. Normally, the Cartwright condition usually focuses on distinct states without considering both micro and macro states together. In traditional applications, the presence of micro and macro states would require a uniquely structured framework. When dealing with complex systems, such as populations generated by design tools, the relationship between micro and macro states becomes crucial. Specifically, design tools generate a vast array of microstates, each corresponding to different macro-states. Hence, the Cartwright condition may be adjusted to accommodate this dual-level analysis. For analysis with design tools, it is important to translate micro-state outcomes back to the level of populations, a process for accurately inferring ontological commitments. This translation is necessary because even if only a small number of microstates are true, they can account for the majority of macrostates observed, signaling true causal influence.

A challenge is bridging micro-level observations to macro-level implications, which uses an additional interpretive step within the framework. In this context, one needs to map the microstate truths back to the overall population. This involves examining combinations of microstates that align with perceived causal outcomes in the macro-state context. By effectively navigating this transition, one can pinpoint specific individuals within the population who embody these combinations of true microstates.

Furthermore, one key output from this analysis is determining how many individuals in the population exhibit these true microstate combinations. This quantification facilitates a deeper understanding of the extent to which these states represent the population. One can derive a metric for ontological commitment by determining the proportion of individuals with true microstates. The percentage measurement of the population embodying these micro-true state combinations becomes pivotal for asserting causality and commitment at the macro level, providing a robust measure that effectively combines micro and macro analysis to contextually inform broader implications. This metric is the output for each query conducted and averaged across sets of queries to provide insight into the level of ontological commitment present.

Using the percentage of the population as a metric for ontological commitment is a logical and insightful approach. By taking the foundational insights provided by the Cartwright condition at the micro level and mapping them back to the macro-level population, this method effectively bridges the gap between individual causal microstates and their broader implications. This approach captures the true essence of ontological commitment by enabling a comparison between specific truths (represented by true causal microstates) and the universe of discourse (represented by the entire population). Importantly, this understanding aids in identifying the necessary encoded and non-encoded relations within a design tool. By discerning which microstates are truly causal and prevalent across the population, designers and engineers can identify if certain relationships are inherently built into the tool's framework or emerge through interactions and contexts. This knowledge is crucial for understanding the results produced by design tools, ensuring transparency in knowledge generation, and aiding in the process of making conceptually robust design decisions.

### Bulk Carrier Synthesis Example

An example multi-objective optimization (MOO) code for a bulk carrier is described below. The code has six inputs: length, draft, depth, block coefficient, beam and speed. The code has three objectives: maximizing transportation cost, maximizing annual cargo and minimizing light ship mass. One or more tensor networks may be developed to perform multi-dimensional contractions, where the results of the contractions may be analyzed by setting the objectives to extreme high and low displacements.

For example, using an objective of maximizing displacement of a vessel, the objective function may be defined as:

$$O ( α ) = {e}^{- {T}_{Critical} * PMI ( α ) * Cost} \qquad Equation 4$$

$$where Cost = {e}^{- ( \frac{Displacement ( α )}{1 , 000 , 000} )} \qquad Equation 5$$

$$and Displacment ( α ) = L * B * T * D * {C}_{b} \qquad Equation 6$$

Alpha represents a given state configuration. The displacement is averaged based on the data points in each respective state configuration, and the state configurations are determined by the number of states for each node. For example, the states may be determined to be a change in value for every meter, meter per second, or every hundredth change in block coefficient. The above equations are provided as an example for purposes of illustration, but other example embodiments may use other suitable equations, other objective functions, etc.

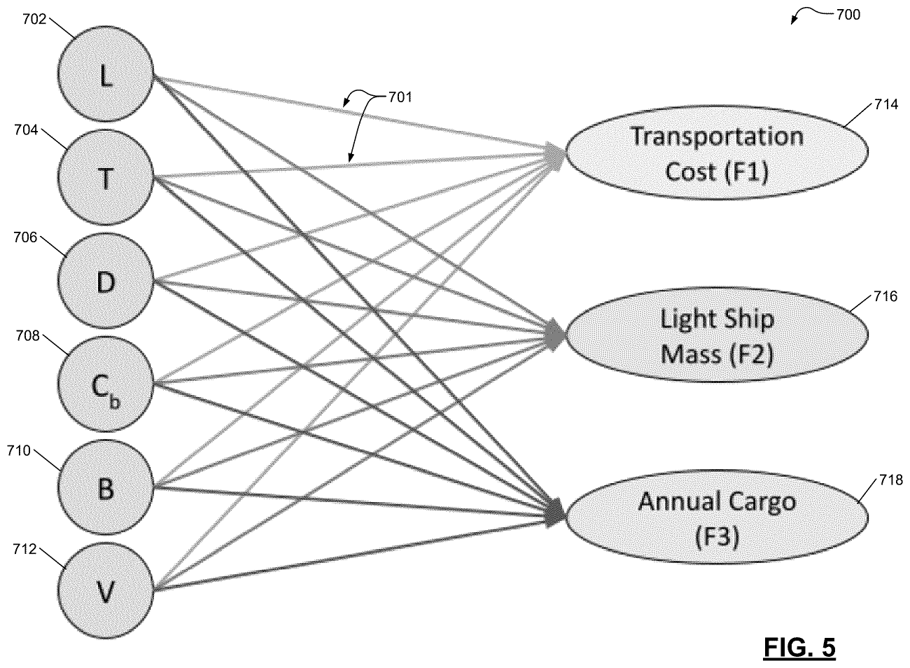

FIG. 5 illustrates an example bulk carrier tensor system 700, which may be used to analyze a bulk carrier optimization problem. In FIG. 5, the system 700 includes multiple tensors 701, which link input variables to output objectives.

For example, the input variables include a length input 702, a draft input 704, a depth input 706, a block coefficient input 708, a beam input 710 and a speed 712. The output objectives include a transportation cost objective 714, a light ship mass objective 716, and an annual cargo objective 718.

In this example, an initial contraction on optimization was conducted by forcing minimum displacement with an eternal leg on the length input 702, and forcing maximum displacement with an eternal leg on the length input 702. For example, contractions on the network may be performed from a coupling tensor, where an external leg or anchor is put on a length of, e.g., 200. If the external leg is on the length, the output probability distribution shows what length is most probable. If an anchor is placed on a length of 200, the system shows specific probabilities relative to the length being 200.

The external legs and anchors allow for analysis to determine which constraints are driving the network. For example, analyzing the results of the above case indicated that minimizing displacement suggests a smallest possible length, while maximizing displacement suggests a length of about fifty meters less than the largest possible length.

In some examples, results may be dependent on the optimization method, such as using fminimax in MATLAB (e.g., a gradient based optimization method), a one million point uniformly sampled Monte Carlo simulation, etc. Analyzing the results prompted investigation of why the maximized displacement optimization resulted in a most probable length that was not the largest possible length. For example, to investigate whether the region was impacted by constraints of the problem, multiple different tensor networks were created to analyze constraint activity (e.g., non-binding, near-binding, binding) and solution status (e.g., non-pareto, near-pareto, and pareto).

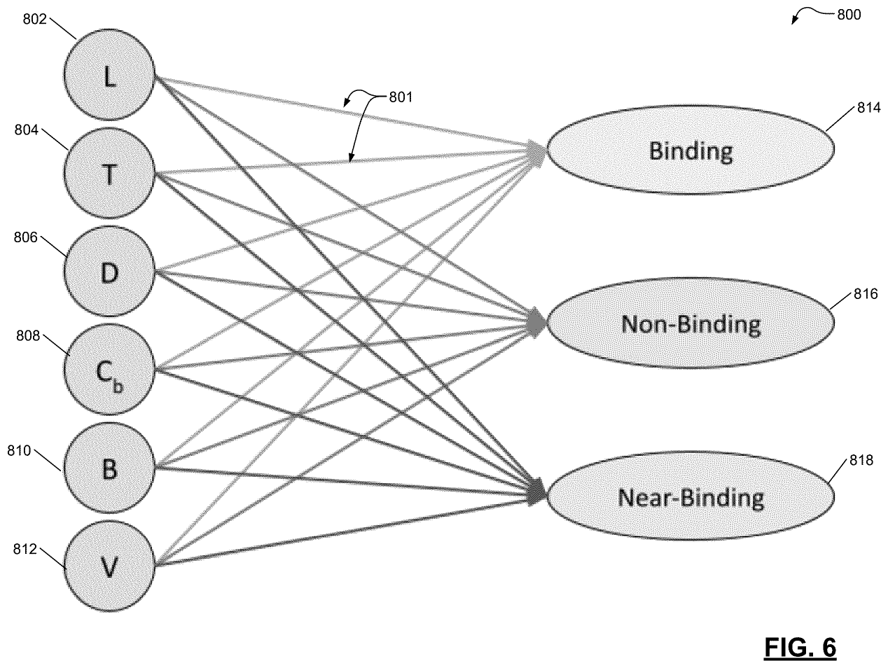

FIG. 6 illustrates an example bulk carrier tensor system 800, which may be used to analyze binding, non-binding and near-binding conditions in a bulk carrier optimization problem. In FIG. 6, the system 800 includes multiple tensors 801, which link input variables to binding conditions.

For example, the input variables include a length input 802, a draft input 804, a depth input 806, a block coefficient input 808, a beam input 810 and a speed 812. The output objectives include a binding status 814, a non-binding status 816, and a near-binding status 818.

The system 800 may be used to determine how many constraints are in the binding status 814, the non-binding status 816 and the near-binding status 818. For example, the length input 802 may be a state vector of all possible lengths. The binding status 814 is a vector indicating how many constraints are in a given state.

The binding status may be set using any suitable criteria, such as criteria defining a constraint condition that cannot be crossed. A near-binding status may indicate a value near the boundary line, while non-binding status is far from the boundary line. The different binding status values may be defined mathematically however desired, any different systems may use other boundary conditions, optimality conditions, etc., than the example binding and pareto conditions described herein. For example, pareto status, near-pareto, non-pareto may be defined mathematically in any desired manner, and other example systems may not use pareto status (e.g., where optimality is used for a single objective system).

The number of constraints may vary depending on the system, such as 13 (or more or less) constraints in some examples. An example constraint could be that a length of the vessel divided by a beam of the vessel is greater than six. Constraints may be determined ahead of time based on, e.g., Monte Carlo simulation of code.

Data may be supplied to coupling tensors 801, and then contractions may be performed on the coupling tensors 801 to see the impact of various constraints. External legs and anchors may be used to investigate the effects of constraints specifically on the system 800.

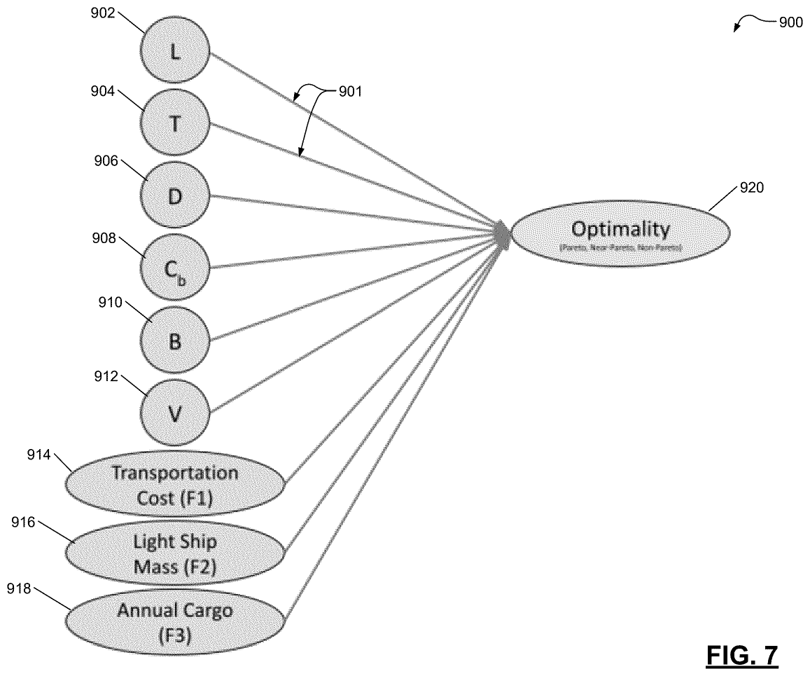

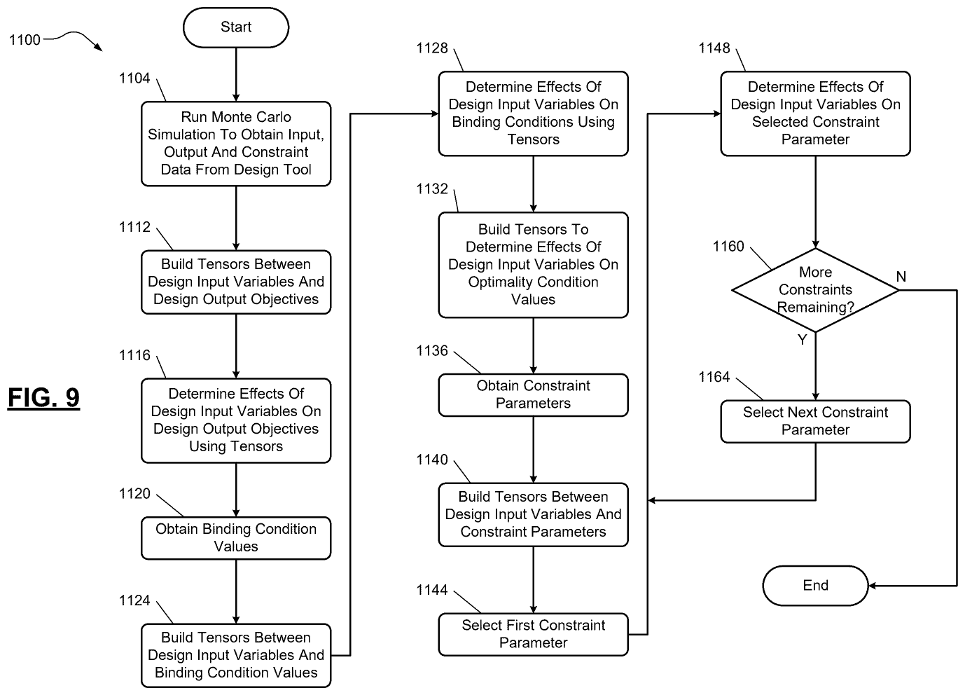

FIG. 7 illustrates an example bulk carrier tensor system 900, which may be used to analyze optimality (e.g., pareto, near-pareto, non-pareto), such as in a bulk carrier optimization problem. In FIG. 9, the system 900 includes multiple tensors 901, which link input variables to optimality conditions.

For example, the input variables include a length input 902, a draft input 904, a depth input 906, a block coefficient input 908, a beam input 910 and a speed 912. The system 900 may receive inputs from the objective functions of transportation cost 914, light ship mass 916 and annual cargo 918. The tensors 901 link the inputs to an optimality output 920, which may include pareto, near-pareto, non-pareto, etc.

In some examples, input variables and outputs of objective functions are all node 1, and optimality is node 2 (e.g., pareto, near-pareto, non-pareto). Each run of the code may provide an output of transportation cost, light ship mass, annual cargo, where a combination of all three outputs determines if a point is pareto, near-pareto, or non-pareto. A Monte Carlo simulation may be used to determine where an objective lies in the population, where optimal points lie in the population, relative to inputs and outputs, etc. For example, in a bulk carrier optimization case, simulations may indicate that a pareto length value lies in a range around 450 for maximizing displacement, and around 200 for minimizing displacement. This approach may be used to determine where optimal solutions lie relative to a variable or an output.

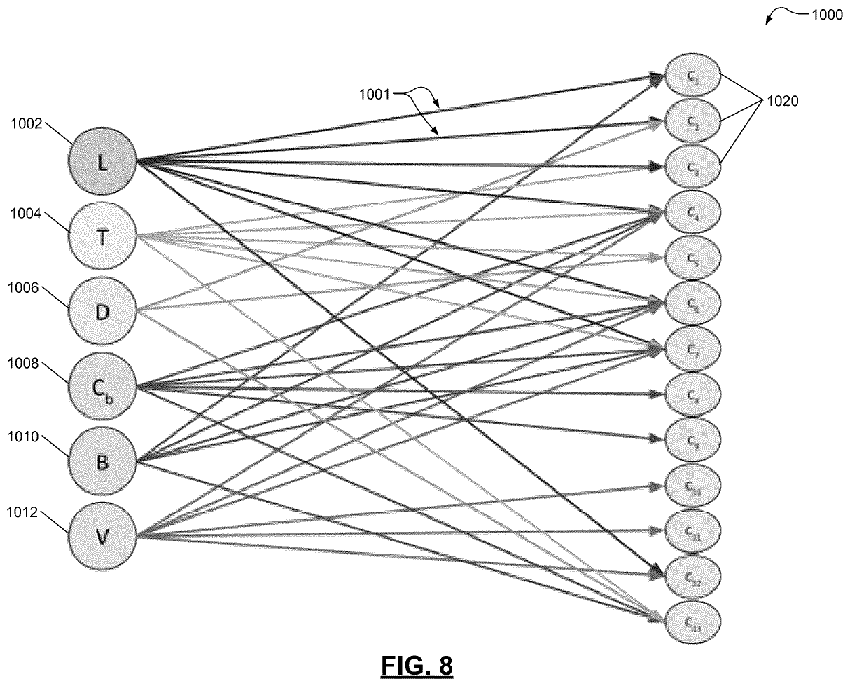

FIG. 8 illustrates an example bulk carrier tensor system 1000, which may be used to analyze the effects of constraints in a bulk carrier optimization problem. In FIG. 8, the system 1000 includes multiple tensors 1001, which link input variables to constraints.

For example, the input variables include a length input 1002, a draft input 1004, a depth input 1006, a block coefficient input 1008, a beam input 810 and a speed 1012. The constraints 1020 may include any suitable constraint values, which may be specified by system, an administrator of the model, etc. In the present example, the constraints may be related to a bulk carrier optimization model.

As an example, a first one of the constraints 1020 may be that a value of the length input 1002 divided by a value of the beam input 1010 must be greater than six. In this example, the only inputs to the first constraint 1020 (e.g., the C1 node) are tensors 1001 linked to the length input 1002 and the beam input 1010.

Each constraint 1020 may have three possibilities, such as a binding status, a near-binding status, and a non-binding status (e.g., a 0, 1 or 2 state). The coupling tensors 1001 may be used to determine whether a constraint 1020 is going to be binding or not for various regions of input values (such as a region of the length input 1002 and a region of the beam input 1010 for the first constraint 1020). This may be used to rule out some constraints that do not have significant impact on the system.

In some examples, two-dimensional contractions of a network (e.g., via coupling tensors) may be used to show where populations of solutions exist. For example, a bulk carrier optimizer code (or other design system) may be run in an optimizer environment (e.g., MATLAB), to determine a range of optimal solutions. In the bulk carrier case, the 2D contractions may be used to determine whether changing constraints would allow for larger input values, such as whether increasing a deadweight constraint would allow for a larger value of the length input 1002, etc.

In some example embodiments described herein, statistical physics may be used for investigation of design tools, such as a bulk carrier or other ship design architecture. The system may be used to determine optimal design constraints, such as using tensor networks to investigate ship design constraints.

Tensor networks may be set up differently for different tools. The tensor networks may allow a system designer to open the black box of a multi-objective design problem, to improve design optimization. Example approaches described herein may be applied to any suitable engineering design tool.

In some examples, tensor networks may be used for fault detection of a code, such as code verification or diagnostics. The tensor networks may be used to determine how to modify code to achieve a desired objective. For example, the tensor networks may be used to determine constraints that can be removed to achieve a desired objective.

Although FIGS. 4-7 illustrate four example cases of using tensors to investigate design synthesis and optimization tool, in some examples more or less (or other) tensor networks may be used for analysis of different tools. For example, only 1 or 2 of the networks may be used in some cases, such as to only examine the effect of input variables on output objectives (e.g., as shown in FIG. 5), or examining the effect of input variables to constraints (e.g., as shown in FIG. 8). Each network may run independently of others, and the order of network execution may vary from case to case. For example, a network may be built once, but contracted ten times (or more or less) with different external legs, using the same network.

### Multi-Objective Design Optimization Process

FIG. 9 illustrates an example process 1100 analyzing a multi-objective optimization design using one or more tensor networks. At 1104, the process begins by obtaining data from a design tool, such as a design synthesis or optimization tool. For example, a Monte Carlo simulation may be run to obtain input variables, output variables or objectives, constraint data, etc., from a design tool.

In a bulk carrier design architecture tool, for example, the input variables may be vessel length, draft, depth, block coefficient, beam, speed, etc. The design output objectives may include transportation cost, light ship mass, annual cargo, etc. The process includes, at 1112, building tensors between design input variables and design output objectives (such as the tensors 701 in FIG. 5).

At 1116, the process includes determining effects of the design input variables on design output objectives using the tensors. An example of investigating the effect of ship lengths on minimum and maximum displacement is described above relative to FIG. 5.

The process obtains binding condition values at 1120, and builds tensors between the design input variables and binding condition values at 1124. For example, binding condition values may include a binding status, a near-binding status, a non-binding status, etc.

At 1128, the process includes determining effects of design input variables on the binding conditions, using the tensors. An example of using tensors to determine effects of deign input variables on binding conditions is described above with reference to FIG. 6.

The process includes, at 1132, building tensors between design input variables and optimality condition values. Example optimality condition values may include, but are not limited to, pareto status, near-pareto status, non-pareto status, etc. In some examples, tensors may be connected between output objectives and optimality condition values.

The tensors may be used to determine effects of the design input variables on optimality condition values. An example of tensors coupled between design input variables and optimality condition values is discussed above relative to FIG. 7.

At 1136, the process includes obtaining constraint parameters. The constraint parameters may include any suitable constraints set for the design system. For example, in the bulk carrier optimization design a constraint may be set as requiring a length at least six times greater than a beam width.

At 1140, the process includes building tensors between the design input variables and the constraint parameters. An example of tensors coupled between design input variables and constraint parameters is described above relative to FIG. 8.

The process selects a first constraint parameter at 1144, and determines the effect of design input variables on the selected constraint parameter at 1148. The constraint effect analysis may be used to give feedback to a system designer, to let them know where the code may be limiting their design efforts in achieving an objective, etc. For example, if the tensor network analysis indicates that the constraint parameter is not impacting the system, a system designer or administrator may remove the constraint parameter from the design model

At 1160, the process determines whether any further constraint parameters remain. If so, the process selects a next constraint parameter at 1164, and returns to 1148 to determine effects of the design input variables on the selected constraint parameter at 1148.

### Framework Main Query Algorithm

An example main query algorithm may take in inputs discussed above, and for each query of interest, the generate and contract the necessary tensor networks. The results from the contraction are then taken, and each possible condition is checked with the Cartwright condition. Once checked, the true conditions are then mapped back to the population, and results are printed and saved to an output file. An example structure of the function for checking the Cartwright condition is included below, along with the structure of the main query algorithm for the developed framework.

An example main query algorithm includes:

```
  Require: Node List ( Config File)
  Require: Edge List ( Config File)
  Require: Query List ( Config File)
  Require: Results File Name
  Require: Node Dim Data Dictionary ( Config File)
  Require: Edge Data Dictionary ( Config File)
  Require: Edge Temps Dictionary ( Config File)
  Require: Data File Path
  Require: Temperature Value
  1: for each query in the list of queries do
  2: Generate the tensor network
  3: Place external legs on E, C, and all K nodes
  4: Contract the tensor network (P(E, C, K))
  5: Clear and regenerate the tensor network
  6: Place external legs on E, and all K nodes
  7: Contract the tensor network (P(E, K))
  8: check- cartwright_conditions(P(E, C, K), P(E, K))
  9: Make a data frame of the true conditions
  10: Map and match the true conditions back onto the population
  11: Print and save to the results file the number of true microstates
  12: Print and save to the results file the number of false microstates
  13: Print and save to the results file the percent of the population
corresponding to true
  microstates
  14: end for
```

An example function to check Cartwright conditions includes:

```
  1: Function: check -cartwright_conditions(P(E, C, K), P(E, K))
  2: Initialize counts of true and false conditions to 0
  3: Initialize results as an empty dictionary
  4: Compute joint_prob_sum-over_A as Σₐₓᵢₛ₌₀ P(E, C, K)
  5: Compute marginalized_prob_sum_over_A as Σₐₓᵢₛ₌₀ P(E, K)
  6: Create mask_joint_prob for nonzero entries in
joint_prob_sum_over_A
  7: Create mask-marginalized-prob for nonzero entries in marginal
ized_prob_sum_over_A
  8: for each indices in joint_prob.shape do
  9: Set A_cond as indices [0]
  10: Set B_C_cond as indices [ 1: ]
  11: if mask-jo int_prob [B_C_cond] and mask_marginalized_prob [B-
C_cond [ 1: ]] then
  12: Compute prob_A_given_B_C as the joint-prob[indices] divided by
the joint_prob_sum_over_A [B_C_cond]
  13: Compute prob_A_given_C as the marginalized_prob [ ( A_cond, ) +
B-C_cond [ 1: ]] divided by the marginal ized_prob_sum_over_A [B_C_cond [
1:]]
  14: if prob_A_given_B_C > prob_A_given_C then
  15: Increment the true count
  16: Calculate delta as prob_A_given_B_C - prob_A_given_C
  17: Create a list of states corresponding to indices from states_dict
  18: Store states and delta in results
  19: else
  20: Increment the false count
  21: end if
  22: else
  23: Increment the false count
  24: end if
  25: end for
  26: Return the true count, the false count, and the results
```

Both of the example algorithms above may be utilized to generate the main results for example case studies. An additional function was developed to determine the counts of bosons and fermions in these results. This function tracks the frequency of each query based on the states generated by the configuration file-producing algorithm for the tensor network. It identifies state combinations containing one individual (fermions) or multiple individuals (bosons) in the population.

### CONCLUSION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements.

The phrase “at least one of A, B, and C” should be construed to mean a logical (A OR B OR C), using a non-exclusive logical OR, and should not be construed to mean “at least one of A, at least one of B, and at least one of C.” The term “set” does not necessarily exclude the empty set. The term “non-empty set” may be used to indicate exclusion of the empty set. The term “subset” does not necessarily require a proper subset. In other words, a first subset of a first set may be coextensive with (equal to) the first set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. Such apparatuses and methods may be described as computerized apparatuses and computerized methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A computer system comprising:
memory hardware configured to store computer-executable instructions, and a design tool model; and
processor hardware configured to execute the computer-executable instructions to:
obtain multiple input parameters each associated with the design tool model;
obtain multiple output objectives each associated with the design tool model;
build at least one tensor network between the multiple input parameters and the multiple output objectives, the at least one tensor network including one or more tensors each connected between at least one of the multiple input parameters and at least one of the multiple output objectives; and
perform one or more contractions of the at least one tensor network to generate a contraction result, the contraction result indicative of an effect of at least one of the multiple input parameters on at least one of the multiple output objectives.

2. The computer system of claim 1, wherein the processor hardware is configured to:
obtain multiple binding conditions each associated with the design tool model;
build a second tensor network between the multiple input parameters and the multiple binding conditions, the second tensor networks including one or more tensors connected between at least one of the multiple input parameters and at least one of the multiple binding conditions; and
perform one or more contractions of the second tensor network to generate a second contraction result, the second contraction result indicative of an effect of at least one of the multiple input parameters on at least one of the multiple binding conditions.

3. The computer system of claim 2, wherein the multiple binding conditions include at least one of a binding condition or a near-binding condition.

4. The computer system of claim 2, wherein the processor hardware is configured to:
obtain multiple optimality conditions each associated with the design tool model;
build a third tensor network between the multiple input parameters and the multiple optimality conditions, the third tensor network including one or more tensors connected between at least one of the multiple input parameters and at least one of the multiple optimality conditions; and
perform one or more contractions of the third tensor network to generate a third contraction result, the third contraction result indicative of an effect of at least one of the multiple input parameters on at least one of the multiple optimality conditions.

5. The computer system of claim 4, wherein the multiple optimality conditions include at least one of a pareto condition or a near-pareto condition.

6. The computer system of claim 4, wherein:
building the third tensor network includes building one or more tensors between the multiple output objectives and the multiple optimality conditions; and
the third contraction result is indicative of an effect of at least one of the multiple output objectives on at least one of the multiple optimality conditions.

7. The computer system of claim 4, wherein the processor hardware is configured to:
obtain multiple constraint parameters each associated with the design tool model;
build a fourth tensor network between the multiple input parameters and the multiple constraint parameters, the fourth tensor network including one or more tensors each connected between at least one of the multiple input parameters and at least one of the multiple constraint parameters; and
perform one or more contractions of the fourth tensor network to generate a fourth contraction result, the fourth contraction result indicative of an effect of at least one of the multiple input parameters on at least one of the multiple constraint parameters.

8. The computer system of claim 7, wherein at least one of the constraint parameters is coupled with less than all of the multiple input parameters via the fourth tensor network.

9. The computer system of claim 1, wherein the design tool model is a bulk carrier optimization design model.

10. The computer system of claim 9, wherein the multiple input parameters include at least one of a vessel length parameter, a vessel draft parameter, a vessel depth parameter, a block coefficient parameter, a vessel beam parameter, and a vessel speed parameter.

11. The computer system of claim 1, wherein the processor hardware is configured to:
classify each of multiple designs associated with the design tool model as either a boson or a fermion, wherein the boson is defined as a design that possesses one or more shared characteristics or states in response to a given query, and the fermion is defined as a design that has no shared characteristics or states for a same query; and
calculate a ratio of bosons to fermions, wherein the ratio is defined as a sum of bosons divided by a sum of fermions for a set of queries.

12. The computer system of claim 1, wherein the processor hardware is configured to:
placing external legs on specified relevant variables within the at least one tensor network to translate raw state space data into structured joint distributions;
reducing the structured joint distributions to marginal distributions; and
testing a Cartwright condition for each unique state of a population within a context of the marginal distributions.

13. A method of executing tensor networks for design tool synthesis or optimization, the method comprising:
obtaining multiple input parameters each associated with a design tool model;
obtaining multiple output objectives each associated with the design tool model;
building at least one tensor network between the multiple input parameters and the multiple output objectives, the at least one tensor network including one or more tensors each connected between at least one of the multiple input parameters and at least one of the multiple output objectives; and
performing one or more contractions of the at least one tensor network to generate a contraction result, the contraction result indicative of an effect of at least one of the multiple input parameters on at least one of the multiple output objectives.

14. The method of claim 13, further comprising:
obtaining multiple binding conditions each associated with the design tool model;
building a second tensor network between the multiple input parameters and the multiple binding conditions, the second tensor network including one or more tensors connected between at least one of the multiple input parameters and at least one of the multiple binding conditions; and
performing one or more contractions of the second tensor network to generate a second contraction result, the second contraction result indicative of an effect of at least one of the multiple input parameters on at least one of the multiple binding conditions.

15. The method of claim 14, wherein the multiple binding conditions include at least one of a binding condition or a near-binding condition.

16. The method of claim 15, further comprising:
obtaining multiple optimality conditions each associated with the design tool model;
building a third tensor network between the multiple input parameters and the multiple optimality conditions, the third tensor network including one or more tensors connected between at least one of the multiple input parameters and at least one of the multiple optimality conditions; and
performing one or more contractions of the third tensor network to generate a third contraction result, the third contraction result indicative of an effect of at least one of the multiple input parameters on at least one of the multiple optimality conditions.

17. The method of claim 16, wherein the multiple optimality conditions include at least one of a pareto condition or a near-pareto condition.

18. The method of claim 16, wherein:
building the third tensor network includes building one or more tensors between the multiple output objectives and the multiple optimality conditions; and
the third contraction result is indicative of an effect of at least one of the multiple output objectives on at least one of the multiple optimality conditions.

19. The method of claim 16, further comprising:
obtaining multiple constraint parameters each associated with the design tool model;
building a fourth tensor network between the multiple input parameters and the multiple constraint parameters, the fourth tensor network including one or more tensors connected between at least one of the multiple input parameters and at least one of the multiple constraint parameters; and
performing one or more contractions of the fourth tensor network to generate a fourth contraction result, the fourth contraction result indicative of an effect of at least one of the multiple input parameters on at least one of the multiple constraint parameters.

20. The method of claim 19, wherein at least one of the constraint parameters is coupled with less than all of the multiple input parameters via the fourth tensor network.
